(19) United States
(12) Patent Application Publication
(10) Pub. No.: US 2005/0162373 A1
(43) Pub. Date: Jul. 28, 2005

(54) Analog buffer for LTPS amLCD

(75) Inventor: Shin-Hung Yeh, Taipei (TW)

Correspondence Address: DANIEL R. MCCLURE;THOMAS, KAYDEN, HORSTEMEYER & RISLEY, L.L.P., 100 GALLERIA PARKWAY, SUITE 1750, ATLANTA, GA, 30339-5948, US

(73) Assignee: AU Optronics Corporation

(21) Appl. No.: 10/761,211

(22) Filed: Jan. 22, 2004

(51) Int. Cl. G09G 3/36

(52) U.S. Cl. 345/100

(57) ABSTRACT

A buffer circuit for a liquid crystal display device that comprises a first transistor further comprising a gate connectable to an input signal, a first electrode coupled to a first power supply, and- a second electrode connectable to a second power supply, a second transistor further comprising a gate coupled to the second electrode of the first transistor, a first electrode connectable to the first power supply, and a second electrode connectable to the second power supply, a first capacitor being connectable to the input signal storing a voltage of the input signal when connected to the input signal, and providing a first voltage to the gate of the first transistor when disconnected from the input signal, a second capacitor further comprising a terminal coupled to the second electrode of the first transistor and the gate of the second transistor providing a second voltage at the terminal when the first transistor is turned on, and a third capacitor coupled to the first electrode of the second transistor providing a third voltage when the second transistor is turned on, wherein the second voltage further comprises a first offset including a gate to source voltage of the first transistor, and the third voltage further comprises a second offset including a gate to source voltage of the second transistor.

### DESCRIPTION OF THE INVENTION

1. Field of the Invention

This invention relates in general to a liquid crystal display (“LCD”) device and, more particularly, to an analog buffer circuit for an LCD device and a method of compensating an offset voltage in a buffer circuit for an LCD device.

2. Background of the Invention

An active matrix liquid crystal display (“LCD”) device generally includes a display panel and a drive circuit to drive the display panel. The drive circuit further includes gate drivers for selecting rows of gate lines and data drivers for providing pixel signals through data lines to pixels corresponding to selected gate lines. In a low temperature polycrystalline silicon (“LTPS”) LCD, drive circuits may be formed directly on a glass substrate. A data driver of an LTPS LCD typically employs source-follower analog buffers at its output stage. A buffer using a source-follower amplifier outputs a voltage produced by subtracting the gate to source voltage of a transistor from an input voltage through the source-follower amplifier. However, there is a problem that the output voltage of the buffer is susceptible to the variation in the characteristics of a device. There is therefore an increasing demand for a compact buffer not susceptible to the characteristics of a device and having simple circuitry.

An example of the source-follower techniques in the art is disclosed in U.S. Pat. No. 6,469,562 (hereinafter the '562 patent) to Shih et al., entitled “Source Follower with VGS Compensation.” The '562 patent discloses a source follower circuit including a constant current source. However, in an LTPS LCD, each data line may correspond to a buffer. For an increasing demand for higher resolution panels, the buffer circuit of the '562 patent may result in excessive power consumption. Furthermore, the constant current may be adversely affected by a drain to source voltage V_{DS} of a transistor even though theoretically the constant current is proportional to (V_{GS}−V_{T})² when the transistor functions in a saturation region, where V_{GS} is a gate to source voltage, and V_{T} is a threshold voltage of the transistor. As a result, the square term (V_{GS}−V_{T}) is adversely affected, failing to properly provide linear compensation.

### SUMMARY OF THE INVENTION

Accordingly, the present invention is directed to an analog buffer circuit and a method of compensating an offset voltage for an analog buffer that obviate one or more of the problems due to limitations and disadvantages of the related art.

To achieve these and other advantages, and in accordance with the purpose of the invention as embodied and broadly described, there is provided a buffer circuit for a liquid crystal display device that comprises a first transistor further comprising a gate connectable to an input signal, a first electrode coupled to a first power supply, and a second electrode connectable to a second power supply, a second transistor further comprising a gate coupled to the second electrode of the first transistor, a first electrode connectable to the first power supply, and a second electrode connectable to the second power supply, a first capacitor being connectable to the input signal storing a voltage of the input signal when connected to the input signal, and providing a first voltage to the gate of the first transistor when disconnected from the input signal, a second capacitor further comprising a terminal coupled to the second electrode of the first transistor and the gate of the second transistor providing a second voltage at the terminal when the first transistor is turned on, and a third capacitor coupled to the first electrode of the second transistor providing a third voltage when the second transistor is turned on, wherein the second voltage further comprises a first offset including a gate to source voltage of the first transistor, and the third voltage further comprises a second offset including a gate to source voltage of the second transistor.

Also in accordance with the present invention, there is provided a buffer circuit for a liquid crystal display device that comprises a first transistor further comprising a gate connectable to an input signal, a second transistor further comprising a gate coupled to an electrode of the first transistor, a first capacitor being connectable to the input signal and the gate of the first transistor storing a voltage of the input signal when connected to the input signal, and providing the voltage of the input signal to the gate of the first transistor when disconnected from the input signal, a second capacitor coupled to the gate of the second transistor providing a voltage to the gate of the second transistor including a first offset component when the first transistor is turned on, and a third capacitor providing a voltage including a second offset component to neutralize the first offset component when the second transistor is turned on.

Still in accordance with the present invention, there is provided a buffer circuit for a liquid crystal display device that comprises a first capacitor being connectable to an input signal storing a reference voltage during a first period, and storing a voltage of the input signal during a second period after the first period, a second capacitor providing a voltage including a first offset during the first period, and providing a voltage including another first offset to neutralize the first offset during the second period, a third capacitor providing a voltage including a second offset during the first period, and providing a voltage including another second offset to neutralize the second offset during the second period, and a fourth capacitor storing the first and second offsets during the first period.

Further in accordance with the present invention, there is provided a method of compensating an offset voltage in a buffer circuit for a liquid crystal display device that comprises providing an input signal, charging a first capacitor with a voltage of the input signal, providing the voltage of the input signal to a first transistor, turning on the first transistor, storing a voltage including a first offset voltage in a second capacitor, the first offset voltage further comprising a gate to source voltage of the first transistor, turning on a second transistor, and storing a voltage including a second offset voltage in a third capacitor, the second offset further comprising a gate to source voltage of the second transistor.

Yet still in accordance with the present invention, there is provided a method of compensating an offset voltage in a buffer circuit for a liquid crystal display device that comprises providing a reference signal, determining a first offset for a first transistor, storing the first offset, determining a second offset for a second transistor, storing the second offset, providing an input signal different from the reference signal, determining another first offset for the first transistor, storing the other first offset, determining another second offset for the second transistor, storing the other second offset, and neutralizing the first and second offsets with the other first offset and the other second offset.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIGS. 1A, 1B and 1C are circuit diagrams of an analog buffer in accordance with one embodiment of the present invention; and

FIGS. 2A, 2B, 2C and 2D are circuit diagrams of an analog buffer in accordance with another embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

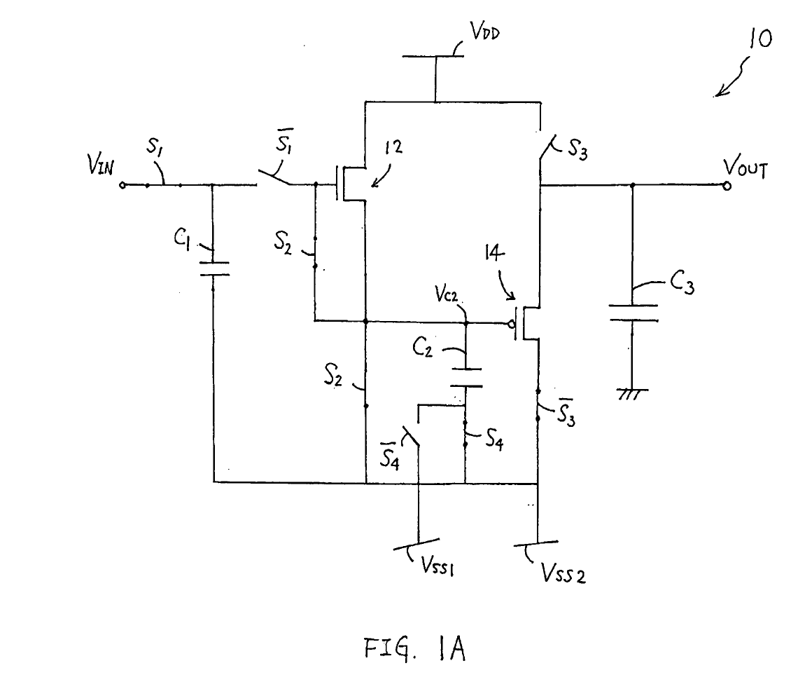

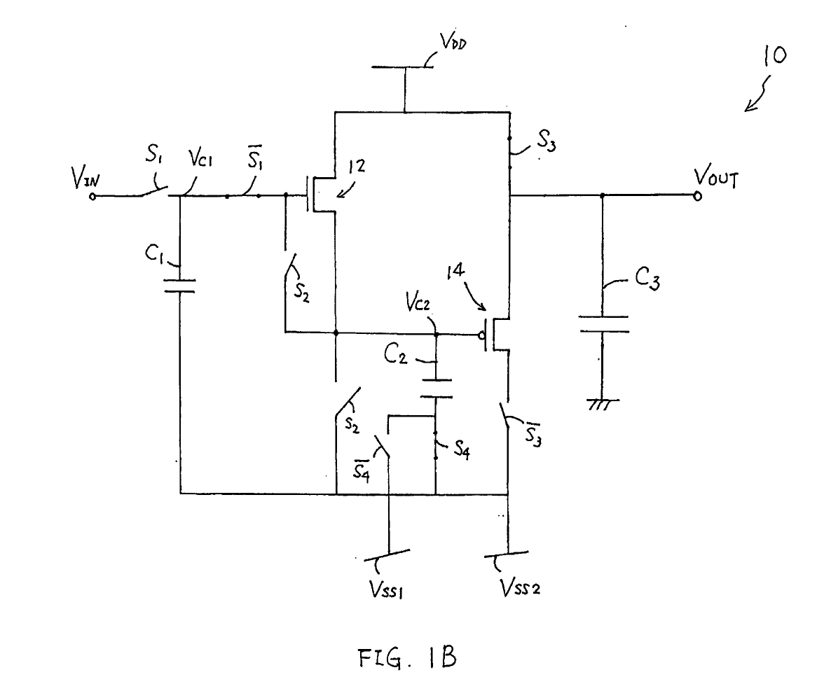

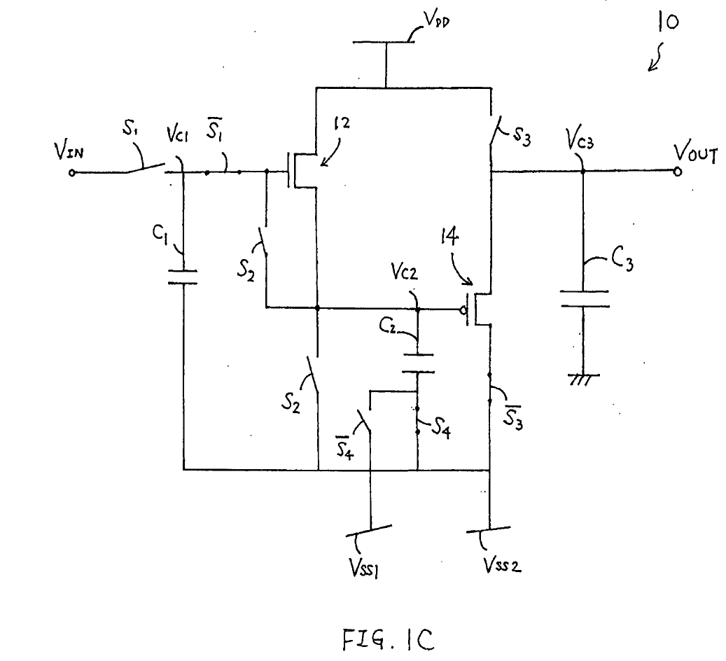

FIGS. 1A, 1B and 1C are circuit diagrams of an analog buffer 10 in accordance with one embodiment of the present invention. Analog buffer 10 functions to serve as a source follower wherein an output voltage V_{OUT} follows an input voltage V_{IN}. Analog buffer 10 includes a first transistor 12, a second transistor 14, a first capacitor C₁, a second capacitor C₂, and a third capacitor C₃. Analog buffer 10 further includes a plurality of switches S₁, \overline{S₁}, S₂, S₃, \overline{S₃}, S₄ and \overline{S₄}, in which S₁ and \overline{S₁}, S₃ and \overline{S₃}, and S₄ and \overline{S₄} are switch pairs. A switch pair refers to a pair of switches operating in opposite switch conditions. For example, when switch S₁ is closed, \overline{S₁} is open, and vice versa.

First transistor 12 includes a gate (not numbered), a source (not numbered), and a drain (not numbered). The gate of first transistor 12 is coupled to input voltage V_{IN} through switch pair S₁ and \overline{S₁}, to first capacitor C₁ through switch \overline{S₁}, and to second capacitor C₂ and second transistor 14 through switch S₂. The drain of first transistor 12 is coupled to a power supply line V_{DD}. The source of first transistor 12 is coupled to second capacitor C₂ and a gate of second transistor 14, and also coupled to a power supply line V_{SS2} through another switch S₂. Second transistor 14 includes a gate (not numbered), a source (not numbered), and a drain (not numbered). The gate of second transistor 14 is coupled to the source of first transistor 12 and second capacitor C₂. The drain of second transistor 14 is coupled to V_{SS2} through switch \overline{S₃}. The source of second transistor 14 is coupled to V_{DD} through switch S₃, and to third capacitor C₃. Second capacitor C₂ includes one end (not numbered) coupled to the source of first transistor 12 and the gate of second transistor 14, and the other end (not numbered) coupled to V_{SS2} through switch S₄, and to a power supply line V_{SS1} through switch \overline{S₄}.

In one embodiment according to the invention, V_{DD} is approximately 9 V (volts), V_{SS2} is approximately −6 V, V_{SS1} is greater than V_{SS2} or approximately 0 V, and V_{IN} ranges approximately from 0 to 4 V.

Analog buffer 10 operates in three stages in sequence to provide output voltage V_{OUT}. These stages are reset and sample, charge, and discharge and hold, which are illustrated in FIGS. 1A, 1B and 1C, respectively.

Referring to FIG. 1A, analog buffer 10 operates in the reset and sample stage. During this stage, switches S₁, S₂, \overline{S₃} and S₄ are closed, and switches \overline{S₁}, S₃ and \overline{S₄} are open. Input voltage V_{IN} is stored in first capacitor C₁ and isolated from the gate terminal of first transistor 12 because switch S₁ is closed and switch \overline{S₁} is open. A voltage V_{C1} at one end (not numbered) of first transistor C₁ is approximately V_{IN}. Since the gate terminal of first transistor 12 is biased at V_{SS2}, first transistor 12 is turned off. Second transistor C₂ is discharged to a power supply line V_{SS2} because switch S₂ is closed. A voltage V_{C2} at one end (not numbered) of second capacitor C₂ is pulled to V_{SS2}. As a result, input voltage V_{IN} is sampled and second capacitor C₂ is reset in the reset and sample stage.

Referring to FIG. 1B, analog buffer 10 operates in the charge stage. During this stage, switches \overline{S₁}, S₃ and S₄ are closed, and switches S₁, S₂, \overline{S₃} and \overline{S₄} are open. First transistor 12 is turned on by the voltage V_{C1} provided by first capacitor C₁ and may operate in a saturation region. A voltage at the source of first transistor 12, that is, V_{C2}, is pulled to V_{C1}−V_{GS1}, where V_{GS1} is the gate to source voltage of first transistor 12. As a result, second capacitor C₂ is charged to V_{C1}−V_{GS1}. On the other hand, since switch S₃ is closed, third capacitor C₃ is charged to V_{DD}.

Referring to FIG. 1C, analog buffer 10 operates in the discharge and hold stage. During this stage, switches \overline{S₁}, \overline{S₃}× and S₄ are closed, and switches S₁, S₂, S₃ and \overline{S₄} are open. Since switch \overline{S₃} is open and switch S3 is closed, second transistor 14 is turned on and may operate in a saturation region. Third capacitor C₃ is discharged through second transistor 14. The voltage V_{C3} at the source of second transistor 14 is discharged to approximately V_{C2}+V_{SG2}, that is, V_{C1}−V_{GS1}+V_{SG2} or V_{IN}−V_{GS1}+V_{SG2}, where V_{SG2} is the source to gate voltage of second transistor 14. As a result, output voltage V_{OUT} is held at the voltage level V_{IN}−V_{GS1}+V_{SG2}.

After the discharge and hold stage, switch \overline{S₄} is closed and switch S₄ is open to turn off first transistor 12 and second transistor 14, resulting in a decrease of leakage current. The voltages V_{GS1} and V_{SG2} are substantially equal to the threshold voltages Vₜₕ₁ and Vₜₕ₂ of first transistor 12 and second transistor 14, respectively, when transistors 12 and 14 are turned off from a saturation region. The output voltage V_{OUT} becomes approximately V_{IN}−Vₜₕ₁+|Vₜₕ₂|, advantageously resulting in a linear compensation of input voltage V_{IN}.

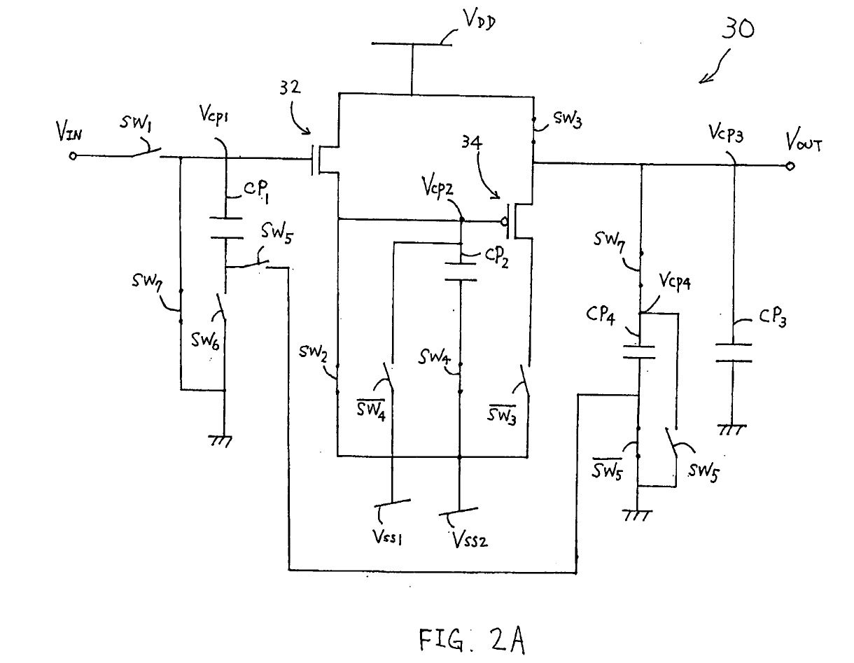

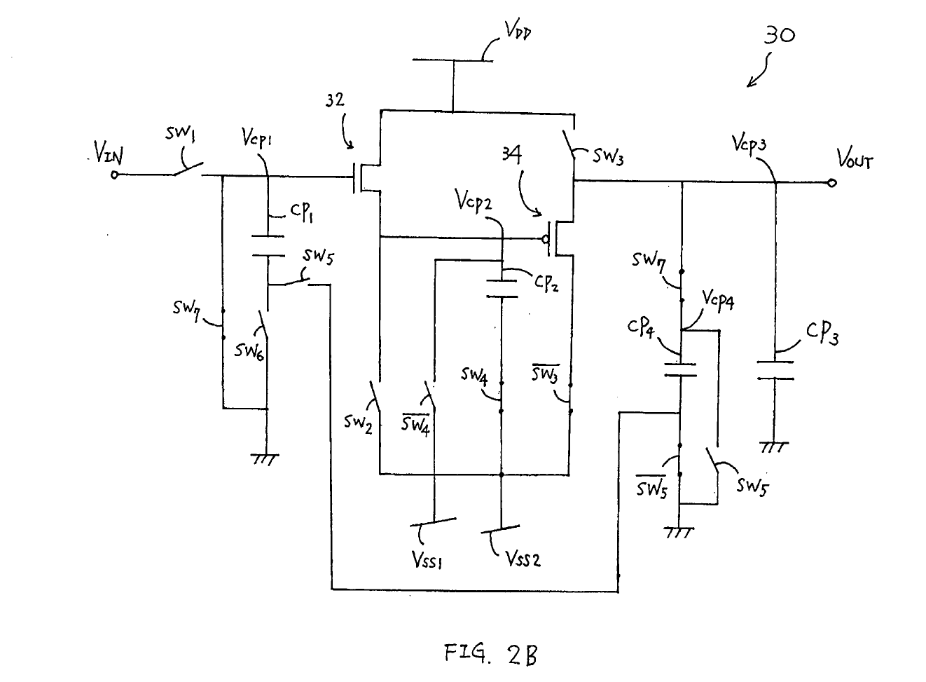

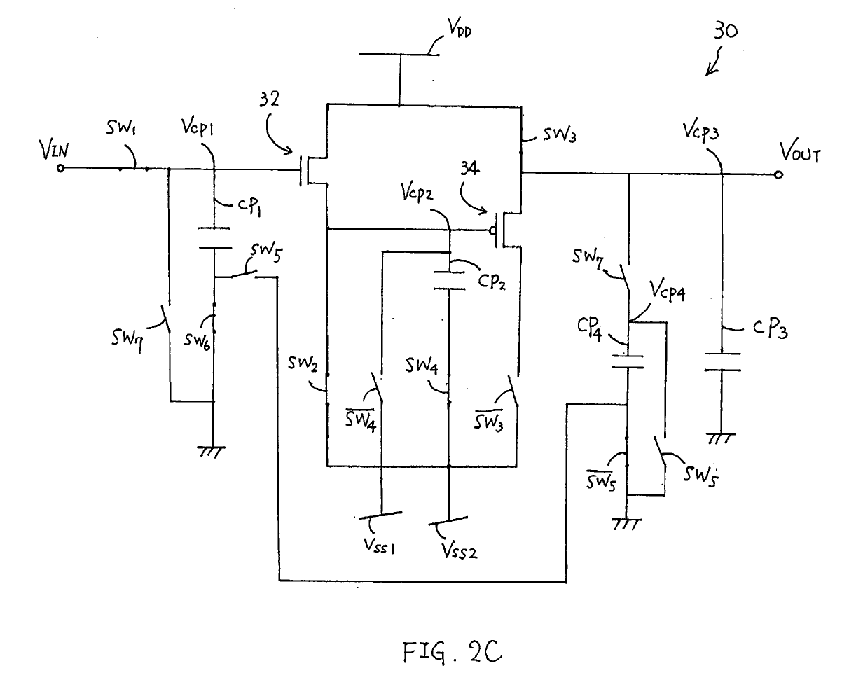

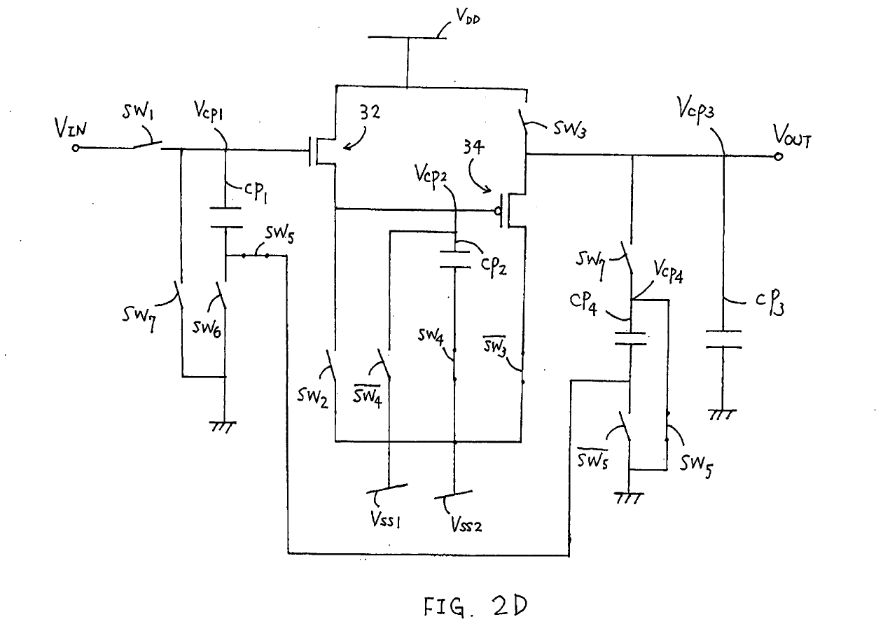

FIGS. 2A, 2B, 2C and 2D are circuit diagrams of an analog buffer 30 in accordance with another embodiment of the present invention. Analog buffer 30 includes a first transistor 32, a second transistor 34, a first capacitor CP₁, a second capacitor CP₂, a third capacitor CP₃, and a fourth capacitor CP₄. Analog buffer 30 further includes a plurality of switches SW₁, SW₂, SW₃, \overline{SW₃}, SW₄, \overline{SW₄}, SW₅, \overline{SW₅}, SW₆ and SW₇, in which SW₃ and \overline{SW₃}, SW₄ and \overline{SW₄}, and SW₅ and \overline{SW₅} are switch pairs.

First transistor 32 includes a gate (not numbered), a source (not numbered), and a drain (not numbered). The gate of first transistor 32 is coupled to input voltage V_{IN} through switch SW₁, to a ground level through switch SW₇, and to one end (not numbered) of first capacitor CP₁. The other end (not numbered) of first capacitor CP₁ is coupled to one end (not numbered) of fourth capacitor CP₄ through switch SW₅, and to a ground level through switch SW₆. The drain of first transistor 32 is coupled to a power supply line V_{DD}. The source of first transistor 32 is coupled to second capacitor CP₂ and a gate of second transistor 34, and also coupled to a power supply line V_{SS2} through switch SW₂.

Second transistor 34 includes a gate (not numbered), a source (not numbered), and a drain (not numbered). The gate of second transistor 34 is coupled to the source of first transistor 32 and second capacitor CP₂. The drain of second transistor 34 is coupled to V_{SS2} through switch \overline{SW₃}. The source of second transistor 34 is coupled to V_{DD} through switch SW₃, to third capacitor CP₃, and to fourth capacitor CP₄ through switch SW₇.

Second capacitor CP₂ includes one end (not numbered) coupled to the source of first transistor 32, the gate of second transistor 34, and to a power supply line V_{SS1} through switch \overline{SW₄}. The other end (not numbered) of second capacitor CP₂ is coupled to V_{SS2} through switch SW₄. Fourth capacitor CP₄ includes one end (not numbered) coupled to the source of second transistor 34 through SW₇, and to a ground level through SW₅. The other end (not numbered) of second capacitor CP₄ is coupled to first capacitor CP₁ through another switch SW₅, and to the ground level through \overline{SW₅}.

Analog buffer 30 operates in four stages in sequence to provide output voltage V_{OUT}. These stages are first reset and sample, first discharge and hold, second reset and sample, and second discharge and hold, which are illustrated in FIGS. 2A, 2B, 2C and 2D, respectively.

Referring to FIG. 2A, analog buffer 30 operates in the first reset and sample stage. During this stage, switches SW₂, SW₃, SW₄, \overline{SW₅} and SW₇ are closed, and switches SW₁, \overline{SW₃}, \overline{SW₄}, SW₅ and SW₆ are open. Input voltage V_{IN} is isolated from first transistor 32 because switch SW₁ is open. Since switch SW₇ is closed, a voltage V_{CP1} at the one end of first capacitor CP₁ is zero. Since switches SW₂ and SW₄ are closed, a voltage V_{CP2} at the one end of second capacitor CP₂ is pulled to V_{SS2}. First transistor 32 is turned on and may operate in a saturation mode. As a result, a zero voltage is sampled and second capacitor CP₂ is reset. After switches SW₇, SW₂ and SW₄ are closed, switches SW₃ and \overline{SW₅} are closed to charge third capacitor CP₃ and fourth capacitor CP₄. A voltage V_{VP3} at the one end of third capacitor CP₃ and a voltage V_{CP4} at the one end of fourth capacitor CP₄ are charged to V_{DD}.

Referring to FIG. 2B, analog buffer 30 operates in the first discharge and hold stage. During this stage, switches SW₄, \overline{SW₃}, \overline{SW₅} and SW₇ are closed, and switches SW₁, SW₂, SW₃, \overline{SW₄}, SW₅ and SW₆ are open. Since switch SW₂ is open, a voltage at the source of first transistor 32, that is, V_{CP2}, is pulled to 0−V_{GS1} or −V_{GS1}, where V_{GS1} is the gate to source voltage of first transistor 12. Since switch SW₃ is open and switch \overline{SW₃} is closed, second transistor 34 is turned on and may operate in a saturation region. Third capacitor CP₃ and fourth capacitor CP₄ are discharged through second transistor 34. The voltages V_{CP3} and V_{CP4} are discharged to −V_{GS1}+V_{SG2}, where V_{SG2} is the source to gate voltage of second transistor 34 at the time t₀. As a result, an offset voltage −V_{GS1}+V_{SG2} in response to an input level of zero is held in capacitor CP₃. The offset voltage determined at the first and second stages will be used later to compensate for input signal V_{IN}.

Referring to FIG. 2C, analog buffer 30 operates in the second reset and sample stage. During this stage, switches SW₁, SW₂, SW₃, SW₄, \overline{SW₅} and SW₆ are closed, and switches \overline{SW₃}, \overline{SW₄}, SW₅ and SW₇ are open. Since switches SW₁ and SW₆ are closed and switch SW₇ are closed, V_{CP1} is charged to V_{IN}. Since switches SW₂ and SW₄ are closed, V_{CP2} is pulled to V_{SS2}. As a result, input voltage V_{IN} is sampled and V_{CP2} is again reset. V_{CP3} is charged to V_{DD} because switch SW₃ is closed. The offset voltage, −V_{GS1}+V_{SG2}, is kept in fourth capacitor CP₄ because switches SW₅ and SW₇ are open and switch \overline{SW₅} is closed.

Referring to FIG. 2D, analog buffer 30 operates in the second discharge and hold stage. During this stage, switches SW₄, \overline{SW₃}, SW₅ are closed, and switches SW₁, SW₂, SW₃, \overline{SW₄}, \overline{SW₅}, SW₆ and SW₇ are open. Since switch SW₅ is closed, first capacitor CP₁ and fourth capacitor CP₄ are connected back to back. The voltage V_{CP1} is pulled to V_{IN}−(−V_{GS1}+V_{SG2}). Since switch SW₂ is open, V_{CP2} is pulled to V_{IN}−(−V_{GS1}+V_{SG2})−V_{GS1}. When second transistor 34 is later turned on, V_{CP3} is discharged to V_{IN}−(−V_{GS1}+V_{SG2})−V_{GS1}+V_{SG2}, or V_{IN}, which is then held at third capacitor CP₃. As a result, the input signal V_{IN} is compensated at the third and fourth stages by the offset voltage, that is, −V_{GS1}+V_{SG2}, obtained at the first and second stages.

The present invention also provides a method of compensating an offset voltage in a buffer circuit for a liquid crystal display device. An input signal V_{IN} is provided. A first capacitor C₁ is charged with a voltage of the input signal V_{IN}. The voltage of the input signal V_{IN} is provided to a first transistor 12. The first transistor 12 is turned on. A voltage V_{C1} including a first offset voltage V_{GS1} is stored in a second capacitor V_{C2}. The first offset voltage V_{GS1} further comprises a gate to source voltage of first transistor 12. A second transistor 14 is turned on. A voltage V_{C3} including a second offset voltage V_{SG2} is stored in a third capacitor C₃. The second offset V_{SG2} further comprises a gate to source voltage of second transistor 14.

In one embodiment, the first offset voltage further comprises a threshold voltage Vₜₕ₁ of first transistor 12, and the second offset voltage further comprises a threshold voltage Vₜₕ₂ of second transistor 14.

The present invention also provides another method of compensating an offset voltage in a buffer circuit for a liquid crystal display device. A reference signal is provided. A first offset V_{GS1} related to a first transistor 32 is determined. The first offset V_{GS1} is stored. A second offset V_{SG2} related to a second transistor 34 is determined. The second offset V_{SG2} is stored. An input signal V_{IN} different from the reference signal is provided. Another first offset V_{GS1} related to first transistor 32 is determined. The other first offset V_{GS1} is stored. Another second offset V_{SG2} related to second transistor 34 is determined. The other second offset V_{SG2} is stored. The first and second offsets are neutralized with the other first and second offsets.

In one embodiment according to the invention, the first offset is stored in a second capacitor CP₂, and the second offset is stored in a third capacitor CP₃. In another embodiment, the first and second offsets are stored in a fourth capacitor CP₄ In still another embodiment, the other first offset is stored in second capacitor CP₂, and the other second offset is stored in third capacitor CP₃. In another embodiment, the other first and other second offsets are stored in fourth capacitor CP₄.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A buffer circuit for a liquid crystal display device comprising:
a first transistor further comprising a gate connectable to an input signal, a first electrode coupled to a first power supply, and a second electrode connectable to a second power supply;
a second transistor further comprising a gate coupled to the second electrode of the first transistor, a first electrode connectable to the first power supply, and a second electrode connectable to the second power supply;
a first capacitor being connectable to the input signal storing a voltage of the input signal when connected to the input signal, and providing a first voltage to the gate of the first transistor when disconnected from the input signal;
a second capacitor further comprising a terminal coupled to the second electrode of the first transistor and the gate of the second transistor providing a second voltage at the terminal when the first transistor is turned on; and
a third capacitor coupled to the first electrode of the second transistor providing a third voltage when the second transistor is turned on;
wherein the second voltage further comprises a first offset including a gate to source voltage of the first transistor, and the third voltage further comprises a second offset including a gate to source voltage of the second transistor.

2. The circuit of claim 1 further comprising a fourth capacitor including one terminal connectable to the second electrode of the second transistor, and another terminal connectable to the first capacitor.

3. The circuit of claim 1, the first voltage further comprising the voltage of the input signal.

4. The circuit of claim 1, the first voltage further comprising a reference voltage.

5. The circuit of claim 1, the first voltage further comprising the voltage of the input signal and offset voltages including a gate to source voltage each of the first transistor and the second transistor.

6. The circuit of claim 1, the second voltage further comprising the first voltage and an offset voltage including a gate to source voltage of the first transistor.

7. The circuit of claim 1, the third voltage being compensated by a threshold voltage each of the first transistor and the second transistor.

8. The circuit of claim 2, the fourth capacitor providing a fourth voltage when second transistor is turned on.

9. The circuit of claim 8, the fourth voltage further comprising offset voltages including a gate to source voltage each of the first and second transistors.

10. A buffer circuit for a liquid crystal display device comprising:
a first transistor further comprising a gate connectable to an input signal;
a second transistor further comprising a gate coupled to an electrode of the first transistor;
a first capacitor being connectable to the input signal and the gate of the first transistor storing a voltage of the input signal when connected to the input signal, and providing the voltage of the input signal to the gate of the first transistor when disconnected from the input signal;
a second capacitor coupled to the gate of the second transistor providing a voltage to the gate of the second transistor including a first offset component when the first transistor is turned on; and
a third capacitor providing a voltage including a second offset component to neutralize the first offset component when the second transistor is turned on.

11. The circuit of claim 10, the first offset component further comprising a gate to source voltage of the first transistor.

12. The circuit of claim 10, the first offset component further comprising a threshold voltage of the first transistor.

13. The circuit of claim 10, the second offset component further comprising a gate to source voltage of the second transistor.

14. The circuit of claim 10, the second offset component further comprising a threshold voltage of the second transistor.

15. A buffer circuit for a liquid crystal display device comprising:
a first capacitor being connectable to an input signal storing a reference voltage during a first period, and storing a voltage of the input signal during a second period after the first period;
a second capacitor providing a voltage including a first offset during the first period, and providing a voltage including another first offset to neutralize the first offset during the second period;
a third capacitor providing a voltage including a second offset during the first period, and providing a voltage including another second offset to neutralize the second offset during the second period; and
a fourth capacitor storing the first and second offsets during the first period.

16. The circuit of claim 15 further comprising a first transistor and a second transistor.

17. The circuit of claim 16, the first and second offsets further comprising a gate to source voltage of the first transistor and the second transistor, respectively.

18. The circuit of claim 16, the other first and another second offsets further comprising a gate to source voltage of the first and second transistors, respectively.

19. The circuit of claim 15, the reference voltage further comprising a zero voltage.

20. A method of compensating an offset voltage in a buffer circuit for a liquid crystal display device comprising:
providing an input signal;
charging a first capacitor with a voltage of the input signal;
providing the voltage of the input signal to a first transistor;
turning on the first transistor;
storing a voltage including a first offset voltage in a second capacitor, the first offset voltage further comprising a gate to source voltage of the first transistor;
turning on a second transistor; and
storing a voltage including a second offset voltage in a third capacitor, the second offset further comprising a gate to source voltage of the second transistor.

21. The method of claim 20 further comprising compensating the input signal with the first offset voltage and the second offset voltage.

22. The method of claim 20 further comprising storing in the second capacitor a voltage including the voltage of the input signal and an offset voltage including a threshold voltage of the first transistor.

23. The method of claim 20 further comprising storing in the third capacitor a voltage including the voltage of the input signal and including an offset voltage further including a threshold voltage of the second transistor.

24. A method of compensating an offset voltage in a buffer circuit for a liquid crystal display device comprising:
providing a reference signal;
determining a first offset for a first transistor;
storing the first offset;
determining a second offset for a second transistor;
storing the second offset;
providing an input signal different from the reference signal;
determining another first offset for the first transistor;
storing the other first offset;
determining another second offset for the second transistor;
storing the other second offset; and
neutralizing the first and second offsets with the other first offset and the other

25. The method of claim 24, after providing the reference signal, further comprising storing a voltage of the reference signal in a first capacitor, and turning on the first transistor with the voltage of the reference signal.

26. The method of claim 25 further comprising storing the first offset in a second capacitor, and storing the second offset in a third capacitor.

27. The method of claim 26 further comprising storing the first offset and the second offset in a fourth capacitor.

28. The method of claim 25 further comprising storing the other first offset in a second capacitor, and storing the other second offset in a third capacitor.

29. The method of claim 28 further comprising storing the other first offset and the other second offset in a fourth capacitor.

30. The method of claim 24 further comprising determining the first offset as a gate to source voltage of the first transistor.

31. The method of claim 24 further comprising determining the second offset as a gate to source voltage of the second transistor.

32. The method of claim 24 further comprising determining the first offset as a threshold voltage of the first transistor.

33. The method of claim 24 further comprising determining the second offset as a threshold voltage of the second transistor.
